(19) United States
(12) Patent Application Publication
(10) Pub. No.: US 2002/0143447 A1
(43) Pub. Date: Oct. 3, 2002

(54) Diagnostic system for a vehicle

(76) Inventor: Matthew T. Miller, Harrisburg, PA (US)

Correspondence Address: Bruce J. Wolstoncroft, Esquire, Barley, Snyder, Senft & Cohen, LLC, 126 East King Street, Lancaster, PA, 17602, US

(21) Appl. No.: 10/109,944

(22) Filed: Mar. 28, 2002

Related U.S. Application Data
(60) Provisional application No. 60/279,394, filed on Mar. 28, 2001.

(51) Int. Cl. G06F 19/00

(52) U.S. Cl. 701/35; 340/438

(57) ABSTRACT

The invention provides a diagnostic system for use on board a vehicle. The diagnostic system comprises a data recorder for collecting data from various sensors throughout the vehicle. An interface module is provided at the output of the data recorder and is capable of transmitting data over transmission medium to an output device for use in diagnosing vehicle performance and/or component failure.

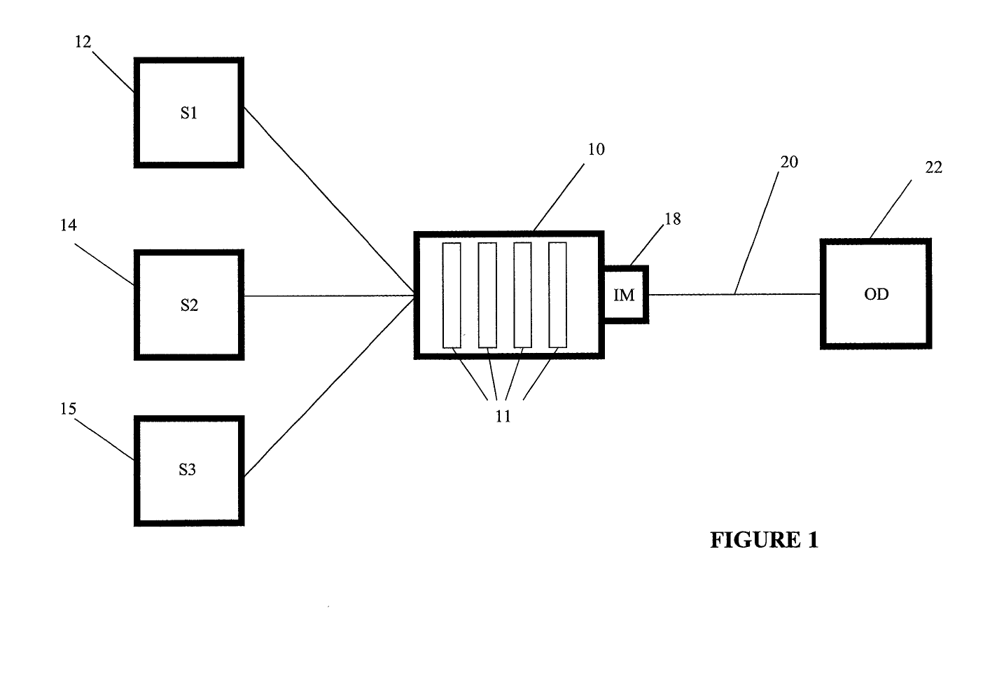

### FIELD OF THE INVENTION

The present invention is related to a diagnostic system for a vehicle and more particularly to such a system of automatically recording and transmitting vehicle diagnostic information to a remote location.

### BACKGROUND

With the ever increasing electronic component content in vehicles comes a need for more sophisticated diagnostic tools. Electronic component failure sometimes occurs slowly beginning with intermittent problems and progressing to complete component failure. These problems are more difficult to diagnose than mechanical failure because often times, there is no visible sign of component failure. Instead, symptoms of a component failure are perceived by intermittent diminished vehicle performance. Microprocessors which are typically utilized for monitoring and self-adjusting electronic components within the vehicle's major systems, are capable of utilizing storage devices for tracking key vehicle measurements. For example, on board microprocessors are capable of tracking vehicle speed, pump operation, ignition timing, door operation, voltage and current values, vehicle location through global positioning systems, and virtually any other on board electronic system. Although diagnostic systems currently exist for downloading error codes generated onboard a vehicle, what is needed is an improved method for transmitting and/or downloading data which has been tracked onboard the vehicle over a given time period. By tracking such data over time, intermittent problems can be identified and corrected.

### SUMMARY

It is therefore an object of the present invention to provide an improved diagnostic system capable of tracking vehicle data and transmitting such data either in real time or in batch form utilizing an appropriate polling or downloading device. Data storage capabilities are provided to store vehicle diagnostic data for a period of time. The stored data can be downloaded at a diagnostic facility or can be transmitted to the facility.

### BRIEF DESCRIPTION OF THE DRAWING

The invention will now be described by way of example with reference to the accompanying FIGURE which shows a block diagram of the diagnostic system according to the present invention.

### DETAILED DESCRIPTION OF THE PREFERRED EMBODIMENTS

The invention will now be described in greater detail with reference to the attached figure. First, the system will be described in general with reference to its major components. The diagnostic system 1 consists of a data recorder 10 typically installed within a vehicle such as an automobile. A plurality of sensors, 12, 14, 16 are connected at various locations within the vehicle for sensing input data. For example, a sensor 12 can be utilized for detecting vehicle speed, a sensor 14 may be utilized for sensing fuel pump operation, while a sensor 16 may be utilized for detecting brake application. Other suitable sensors may be utilized sensing any electronic or electric signal on board the vehicle which will assist in diagnosing typical component or vehicle failures. Other examples of sensors which may be utilized in this application may include but are not limited to air flow sensors, temperature sensors, oxygen sensors, RPM sensors. The data recorder 10 is connectable to an interface module 18 which has an output coupled to a transmission medium 20 which is coupled to an output device 22.

Each of the major components will now be described in greater detail. The data recorder 10 has an embedded micro-controller for receiving and recording input signals from each of the sensors, 12, 14, 16. Alternatively, the data recorder 10 may be connected to an on board vehicle computer which monitors the sensors 12,14,16. In this senario, the data recorder communicates with the on board computer to transfer the sensor data from the on board computer to the data recorder 10. Active components such as operational amplifiers are utilized and incorporated in the data recorder 10 for shifting signal levels from the respective sensor output to appropriate equivalents for input to the micro-controller. Other active components are utilized for synchronizing the micro-controller to each of the sensor inputs. Memory is provided in the data recorder 10 for storing a desired amount of data. This memory may be provided by memory modules inserted into the data recorder 10. Memory modules can therefore be added as necessary to store the desired amount of data from the sensors 12, 14, 16. The data recorder 10 utilizes an output 11, which preferably consists of one or a plurality of electrical connectors such as an RS 232 interface. It should be understood that any other suitable electrical connector interface may be utilized for the output 11.

An interface module 18 is connectable to the data recorder output 11 at selected times for sending data to an output device 22 over a transmission medium 20. The interface module 18 may consist of a variety of components depending upon the frequency and location of data output. For example, the interface module may be a wireless module for transmitting data over a cellular or other wireless network to the output device 22. The interface module 18 may alternatively include a cable 20 connected to the data recorder output 11 at a service location having the output device 22. The interface module 18 may alternatively be a connection to a personal data assistant or equivalent device. Other possible interface modules include a Dallas Semiconductor I-button, a non-volatile memory storage device for providing additional memory or alternate storage or a local area network/modem interface to the internet.

The transmission medium 20 may include an optical, electrical, or wireless interface to the output device 22. For example, in the case where the interface module 18 is one for transmitting wireless signals from the data recorder output 11, the transmission medium 20 would be a cellular or other wireless network. Likewise, if the interface module is a land/modem interface to the internet, the transmission medium 20 would typically consist of an unshielded twisted pair cable assembly connected to an interface module 18 with a modular jack type connector. In this case, the transmission medium 20 would include the components of the Internet such as a plurality of networks and servers. Likewise, an optical network may be a part of the transmission medium 20. In each case, the interface module 18 will include the preferred data recorder output interface 11 consisting of an RS 232 port. This allows any one of the desired interface modules 18 to be utilized with a single data recorder 10. The system 1 is therefore flexible in that data recorded and stored on the vehicle can be transmitted or downloaded in a variety of ways by simply selecting and using the appropriate interface module 18 and transmission medium 20.

The output device 22 is adaptable to be a portable hand-held terminal or portable data assistant. It may also be a personal computer connected to the internet or located at a diagnostic service location. Alternatively, the output device 22 may be a specialized hand-held diagnostic tool which includes an interface module directly connected to the data recorder output 11. Likewise it is evident that the system is flexible in that several different output devices can be utilized with a single data recorder 10.

In operation, the data recorder 10 is programmed to record data from each sensor 12,14,16 at specified intervals and is programmed to transmit such data through its output port 11 to the appropriate interface module 18. The output device 22 is then connected to the interface module 18 over the transmission medium 20 to receive the recorded data. As previously mentioned, the interface module 18 may also include non-volatile memory for storing the received data. It should be understood that the output device 22 may be connected to the interface module 18 at specified intervals in time such as when a vehicle is brought into a service facility or may alternatively be connected to the interface module 18 while the vehicle is in operation over a wireless or other suitable network. The output device 22 may also have the capability of polling the data recorder 10 through the transmission medium 20 and interface module 18 at specified intervals to monitor vehicle performance in real time. Diagnostics are performed by analyzing the data gathered at the output device 22 either upon vehicle arrival at the service facility or in real time or at specified intervals as programmed into the data recorder 10, or upon polling by the output device 22. This system 1 may alternatively be utilized to set an indicator in the vehicle from a remote location when vehicle performance is less than optimal or indicates an impending component failure. In this scenario, the output device 22 would automatically detect the diagnostic information being supplied thereto indicating an impending component failure or service interval. The output device 22 may then send a signal over the transmission medium 20 through the interface module 18 to data recorder 10 to signal the driver through a light or other computer display that service or maintenance is required. When the vehicle arrives at the service facility, the vehicle problem is already diagnosed through the system 1.

It should be understood that the data recorder 10 having the output 11 is connectable to any one of the interface modules 18 described above. For example, the same data recorder 10 may be alternatively connected to a hard wired interface module 18 or to an output device 22 at a service facility during routine maintenance. Alternatively, the same data recorder 10 may be connected to a wireless interface module 18 for continuous monitoring by the output device 22 in real time or at requested intervals. Similarly, any of the interface modules discussed above could be connected to the same data recorder 10 depending upon the desired frequency and method of transmitting diagnostic information to the output device 22. For example, a GPS module, a wireless interface module and a memory module may be inserted to allow data recording into the memory, position information to be stored with the data and interval transmission over the wireless link.

An advantage of the present invention is that it allows for onboard vehicle diagnostic information to be selectively transmitted to an output device by simply replacing an interface module or a plurality of interface modules and selecting an appropriate transmission medium. Additionally, the interval of data transmission may be altered as necessary depending upon the interface module selected and the data interval required in order to diagnose a given vehicle problem.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A system for diagnosing vehicle performance comprising:
a data recorder connected to a plurality of sensors within the vehicle;
an interface module connected to the data recorder;
a transmission medium connected to the interface module; and,
a device connected to the transmission medium for receiving diagnostic information collected at the data recorder.

2. The system of claim 1 wherein the interface module converts electrical signals including data from the data recorder into signals for transmission over a wireless network.

3. The system of claim 2 wherein recorded data is transmitted over the wireless network in real time to the output device.

4. The system of claim 1 wherein the data recorder includes memory for storing data from the plurality of sensors.

5. The system of claim 4 wherein the memory is modular such that it can be added to or subtracted from the data recorder.

6. The system of claim 1 wherein the interface module comprises a non-volatile memory storage device.

7. The system of claim 1 wherein the interface module comprises a computer network interface.

8. The system of claim 1 wherein the data recorder further comprises an output interface.

9. The system of claim 8 wherein the output interface comprises an RS232 port.

10. The system of claim 1 wherein the output device comprises a portable handheld terminal.

11. The system of claim 1 wherein the output device further comprises wireless data receiving capability.

12. The system of claim 1 wherein the interface module, transmission medium and output device are connectable to the data recorder during discrete intervals of time for downloading data recorded over a specified time interval.

13. The system of claim 1 wherein the interface module, transmission medium and output device are continuously connected to the data recorder for continuous monitoring of data gathered by the plurality of sensors.

14. The system of claim 1 wherein the plurality of sensors include a GPS module.

15. The system of claim 1 wherein the plurality of sensors include a temperature sensor.

16. The system of claim 1 wherein the plurality of sensors include a position sensor.

17. The system of claim 1 wherein the plurality of sensors include a speed sensor.

18. The system of claim 1 wherein the plurality of sensors include a fuel pump sensor.

19. The system of claim 1 wherein the plurality of sensors include a brake detection sensor.

20. The system of claim 1 wherein the plurality of sensors include an air flow sensor.

21. The system of claim 1 wherein the plurality of sensors include an oxygen sensor.

22. The system of claim 1 wherein the plurality of sensors include an RPM sensor.
